(19) United States
(12) Patent Application Publication
(10) Pub. No.: US 2006/0275600 A1
(43) Pub. Date: Dec. 7, 2006

(54) Release agent-free, multiple-use, polymer-based composite materials employed for concrete pouring forms and methods of making and using same

(76) Inventors: Frank A. Vavra, Alexandria, VA (US); Steven R. Maimon, Alexandria, VA (US); James C. Taylor, Alexandria, VA (US); William N. Calland, Mt. Vernon, OH (US)

Correspondence Address: FOLEY AND LARDNER LLP;SUITE 500, 3000 K STREET NW, WASHINGTON, DC, 20007, US

(21) Appl. No.: 11/098,542

(22) Filed: Apr. 5, 2005

Related U.S. Application Data
(60) Provisional application No. 60/559,005, filed on Apr. 5, 2004.

(51) Int. Cl. B32B 15/04; B32B 27/00; B32B 21/00

(52) U.S. Cl. 428/332; 428/457; 428/537.1; 428/703; 428/355 AC; 428/347; 428/355 N

(57) ABSTRACT

Polymer-based composite materials comprising a polymer, such as high density polyethylene, and one or more functional fillers, such as powdered metals, carbon, or ceramics, are described. The composite materials can be used for concrete forming applications. For example, the polymer-based composite materials can be formed into sheets and laminated onto various non-metal substrates, such as plywood, for use as concrete pouring forms. The polymer-based composite materials can also be used as facings and liners for metal concrete pouring forms. The forms can be used multiple times without release agents and without staining or physically damaging the cured concrete. The polymer-based composite materials can be provided with various surface textures, patterns, and designs. Methods for bonding the polymer-based composite materials to various non-metal and metal substrates are also described.

### CROSS REFERENCE TO RELATED APPLICATIONS

This application claims priority under 35 U.S.C. §119(e) to Provisional Application No. 60/559,005, entitled “Release Agent-Free, Multiple-Use, Polymer-Based Composite Materials Employed for Concrete Pouring Forms and Methods of Making and Using Same”, and filed Apr. 5, 2004. The entire contents of Provisional Application No. 60/559,005 are incorporated herein by reference.

### BACKGROUND OF THE INVENTION

1. Field of the Invention

The present invention relates generally to polymer-based composite materials for concrete pouring applications and, in particular, to laminated panels comprising such materials, methods of making the laminated panels and the use of the laminated panels as concrete pouring forms.

2. Related Art

In the construction industry, commercially available plywood and similar non-metal products (i.e., primarily BB Plyform and HDO/MDO Overlay with a resin-impregnated paper laminated onto a plywood or particle board substrate), as well as aluminum and steel, with the required structural properties in flat and non-flat (i.e., shaped or contoured) sheets typically are used to construct forms into which concrete is poured to allow for setting and curing of the concrete into specific shapes and dimensions. Typically in such applications, the face of the form that will be in contact with the poured concrete needs to be coated with a release agent, for example, form or diesel or other oil, so that the concrete does not stick to the form during curing, thus permitting the form to be removed from the concrete after it is cured without damage to the surface of the concrete or the form itself, and thus permitting the form to be used again for additional pours.

Plain plywood and metal sheets employed for concrete forming require the use of a release agent for each pour.

Construction industry experience indicates that treated concrete forming products, such as BB Plyform and HDO/MDO Overlay, typically require a release agent after a limited number of pours, typically less than five, due to adherence of the concrete to the surface and damage to the overlay. The protective covering laminated on to the substrate (e.g., resin-impregnated paper) is very thin and of a material that is susceptible to physical damage by the alkalinity of the concrete mix and by the presence of sand, gravel, and other aggregates in the concrete mix and normal handling of the form at the construction site.

The disadvantages of using these types of products for concrete pouring, versus a durable form that does not require a release agent, include primarily: 1) the additional time and labor required to apply the release agent to form and then to clean the release agent from the form after it is removed from the cured concrete; 2) the additional time and labor required to clean any residual release agent, or staining caused by the release agent, from the surface of the cured concrete after the form is removed; 3) the potential additional time, labor and materials required to repair damage, if any, to the surface of the cured concrete after the form is removed, which damage is caused by failure of the release agent, if any, to provide effective release from the surface of the cured concrete; 4) the potential eventual damage to the form caused by the alkalinity of the concrete mix and the presence of sand, gravel and other aggregates in the concrete mix and the chemicals in the release agent, limiting the useful life of the form and thus increasing the number of forms that need to be purchased and then disposed of; and 5) the potential environmental and related impacts resulting from the use of the release agent, including exposure of workers to the oils, contamination of the construction site, the time, labor, and cost of remediation of the site, and fines imposed by OSHA and/or EPA associated with any such exposure and/or contamination.

Furthermore, the relative difficulty of current pouring forms to release cleanly and readily from cured concrete, even with release agents, limits significantly the extent to which functional or decorative textures, patterns, and designs can be incorporated practically in the pouring face of the form, especially if such textures, patterns, and designs embody fine details.

In recent years, in attempts to eliminate, or at least to mitigate significantly, the problems inherent in current pouring form products, as indicated above, various other materials have been employed as pouring surfaces laminated onto the appropriate substrates. These other materials include primarily polyethylene, polypropylene and polyurethane, fiberglass resin (with and without the glass scrim), and various engineered polymers. Construction industry experience indicates that these materials typically also require a release agent after a limited number of pours, typically less than ten pours, and/or are not cost-competitive with current pouring forms and the practices for using them.

Accordingly, it would be advantageous to have durable concrete pouring forms that exhibit excellent release properties, even with surfaces having detailed textures and designs, and that could be reused repeatedly without the use of a release agent, and that are cost-competitive with current pouring forms and the practices for using them.

### SUMMARY OF INVENTION

In one aspect, a composite material for use in a concrete pouring form is provided. The composite material includes at least one thermoplastic material and at least one filler material. The thermoplastic material is selected from the group consisting of polyethylene, polypropylene, and PVC. At least one surface of the composite material is configured for contact with at least one surface of cured concrete. The composite material can be separated from cured concrete without using a release agent, leaving the at least one surface of the composite material and the at least one surface of cured concrete smooth and undamaged. The at least one filler material may be selected from the group consisting of a metal, a ceramic, activated carbon, non-activated carbon, flyash, glass, a natural fiber, a synthetic fiber, an aramid, a natural rubber, a synthetic rubber, sawdust, and combinations thereof.

Respective amounts by weight of the thermoplastic material and the filler material may be provided such that the composite material has a surface energy of less than or approximately equal to 30 dynes/cm. Respective amounts by weight of the thermoplastic material and the filler material may be provided such that the composite material has a surface hardness of greater than or approximately equal to 30 on the Rockwell scale. Respective amounts by weight of the thermoplastic material and the filler material may be provided such that the composite material has both a surface energy of less than or approximately equal to 30 dynes/cm and a surface hardness of greater than or approximately equal to 30 on the Rockwell scale. The amount by weight of the thermoplastic material may constitute at least 40% and at most 95% of the weight of the composite material, and the amount by weight of the filler material may constitute at least 5% and at most 60% of the weight of the composite material. Typically, the amount by weight of the thermoplastic material may constitute at least 55% and at most 75% of the weight of the composite material, and the amount by weight of the filler material may constitute at least 25% and at most 45% of the weight of the composite material. The composite material may exhibit the desired release characteristics for at least 30 concrete pours without using a release agent.

The composite material may be formed into a sheet and bonded to at least one face of a substrate by using an adhesive to form a laminated panel. The substrate may be selected from the group consisting of plywood, a celluloid, a metal, and a second composite material. The adhesive may be selected from the group consisting of one-part acrylics, two-part acrylics, epoxies, polyurethanes, phenolics, hot-melt adhesives, polyvinyl acetates, ethylene vinyl acetates, and pressure-sensitive adhesives, individually, in combination, and/or compounded together. The sheet may have a thickness of at least approximately eight one-thousandths of an inch (0.008″). Exposed surfaces of the substrate may be coated. The coating may allow the removal of excess concrete with which the substrate might come into contact during a concrete pour. The coating may include ceramic particles, or it may include metallic particles. A second sheet of composite material may be bonded to an opposite face of the substrate using an adhesive to form a dual-faced laminated panel. Each face of the dual-faced laminated panel may withstand at least 30 concrete pours without using a release agent. The composite material may have undergone a surface treatment to improve adhesion to a substrate. The surface treatment may be selected from the group consisting of a corona discharge, a flame treatment, a plasma treatment, and combinations thereof.

At least one surface of the composite material may include an adhesive selected from the group consisting of one-part acrylics, two-part acrylics, epoxies, polyurethanes, phenolics, hot-melt adhesives, polyvinyl acetates, ethylene vinyl acetates, and/or pressure-sensitive adhesives, individually, in combination, and/or compounded together. The composite material may further include a removable protective layer positioned over at least a portion of the adhesive.

In another aspect, the invention provides a method of making a laminated panel useful in concrete pouring applications. The method includes the steps of providing a composite material, the composite material including at least one thermoplastic material and at least one filler material; forming the composite material into a sheet having a substantially uniform thickness; and bonding the sheet to the substrate to provide a laminated panel that can be released from cured concrete without using a release agent such that at least one surface of the laminated panel and at least one surface of the cured concrete are left smooth and undamaged. The sheet may be bonded to the substrate using an adhesive. The method may further include contacting a face of the laminated panel, which includes the composite material, with poured concrete. The at least one thermoplastic material may be selected from the group consisting of polyethylene, polypropylene, and PVC. The at least one filler material may be selected from the group consisting of a metal, a ceramic, activated carbon, non-activated carbon, flyash, glass, a natural fiber, a synthetic fiber, an aramid, a natural rubber, a synthetic rubber, sawdust, and combinations thereof. The adhesive may be selected from the group consisting of one-part acrylics, two-part acrylics, epoxies, polyurethanes, phenolics, hot-melt adhesives, polyvinyl acetates, ethylene vinyl acetates, and/or pressure-sensitive adhesives, individually, in combination, and/or compounded together.

Respective amounts by weight of the at least one thermoplastic material and at least one the filler material may be provided such that the composite material has a surface energy of less than or approximately equal to 30 dynes/cm. Respective amounts by weight of the at least one thermoplastic material and the at least one filler material may be provided such that the composite material has a surface hardness of greater than or approximately equal to 30 on the Rockwell scale. Respective amounts by weight of the at least one thermoplastic material and the at least one filler material may be provided such that the composite material has both a surface energy of less than or approximately equal to 30 dynes/cm and a surface hardness of greater than or approximately equal to 30 on the Rockwell scale. The amount by weight of the at least one thermoplastic material may constitute at least 40% and at most 95% of the weight of the composite material, and the amount by weight of the at least one filler material may constitute at least 5% and at most 60% of the weight of the composite material. Alternatively, the amount by weight of the at least one thermoplastic material may constitute at least 55% and at most 75% of the weight of the composite material, and the amount by weight of the at least one filler material may constitute at least 25% and at most 45% of the weight of the composite material.

The substrate may be selected from the group consisting of plywood, a celluloid, a metal, and a second composite material. The sheet may have a thickness of at least approximately eight one-thousandths of an inch. The method may further include coating exposed surfaces of the substrate. The coating may allow the removal of excess concrete with which the substrate might come into contact during a concrete pour. The coating may include ceramic particles, or the coating may include metallic particles. The composite material may have undergone a surface treatment to improve adhesion to the substrate. The surface treatment may be selected from the group consisting of a corona discharge, a flame treatment, a plasma treatment, and combinations thereof.

In yet another aspect, the invention provides a method of making a dual-faced laminated panel useful in concrete pouring applications. The method includes the steps of providing a composite material, the composite material including at least one thermoplastic material and at least one filler material; forming the composite material into a first sheet and a second sheet, each sheet having a substantially uniform thickness; and bonding the first and second sheets to opposite faces of the substrate to provide a dual-faced laminated panel that can be released from cured concrete without using a release agent such that at least one surface of the dual-faced laminated panel and at least one surface of the cured concrete are left smooth and undamaged.

In still another aspect, a composite material for use in a concrete pouring form is provided. The composite material includes at least one thermoplastic material and at least one filler material. The composite material is capable of being released from cured concrete without using a release agent, leaving faces of the composite material and the cured concrete previously in contact with each other smooth and undamaged.

In still another aspect, the invention provides a method of making a composite material for use in concrete pouring applications. The method includes the steps of selecting at least one thermoplastic material and at least one filler material, and combining the at least one thermoplastic material with the at least one filler material to provide a composite material that is capable of being released from cured concrete without using a release agent, leaving faces of the composite material and the cured concrete previously in contact with each other smooth and undamaged.

In yet another aspect, a method of pouring concrete to be cured is provided. The method includes the steps of lining a form into which concrete is to be poured with a composite material, the composite material including at least one thermoplastic material and at least one filler material, and pouring concrete into the lined form. The composite material can be separated from the cured concrete without using a release agent, leaving faces of the composite material and the cured concrete previously in contact with each other smooth and undamaged.

In still another aspect, the invention provides a method of making a form useful in concrete pouring applications. The method includes the steps of configuring a laminated panel into a form into which concrete can be poured, the laminated panel comprising a composite material bonded to a substrate. The composite material is capable of being released from cured concrete without using a release agent, leaving faces of the composite material and the cured concrete previously in contact with each other smooth and undamaged.

In yet another aspect, a composite material for use in a concrete pouring form is provided. The composite material includes at least one polymeric material and at least one filler material. The at least one polymeric material is selected from the group consisting of a thermoplastic material and a thermoset material. At least one surface of the composite material is configured for contact with at least one surface of cured concrete. The composite material can be separated from cured concrete without using a release agent, leaving the at least one surface of the composite material and the at least one surface of cured concrete smooth and undamaged.

In still another aspect, the invention provides a method of making a laminated panel useful in concrete pouring applications. The method includes the steps of providing a composite material; forming the composite material into a sheet having a substantially uniform thickness; and bonding the sheet to the substrate to provide a laminated panel that can be released from cured concrete without using a release agent such that at least one surface of the laminated panel and at least one surface of the cured concrete are left smooth and undamaged. The composite material includes at least one polymeric material and at least one filler material. The at least one polymeric material includes at least one of the group consisting of a thermoplastic material and a thermoset material.

### BRIEF DESCRIPTION OF THE DRAWINGS

FIG. 1 is a cross-section of a laminated panel according to one embodiment of the invention comprising a polymer-based composite material sheet bonded to a substrate by an adhesive layer.

FIG. 2 is a cross-section of a laminated panel according to a further embodiment of the invention comprising a polymer-based composite material sheet bonded to a substrate by an adhesive layer and further comprising a protective coating applied to the exposed surfaces of the substrate.

FIG. 3 is a schematic drawing of a concrete pour form constructed from such laminated panels according to a further embodiment of the invention.

FIG. 4 is a picture of a concrete block made using a concrete pour form as shown in FIG. 3.

### DETAILED DESCRIPTION OF THE INVENTION

The present invention is directed to laminated panels comprising a polymer-based composite sheet bonded to a major surface of an appropriate substrate, methods of making the laminated panels, and the use of the laminated panels as concrete pouring forms.

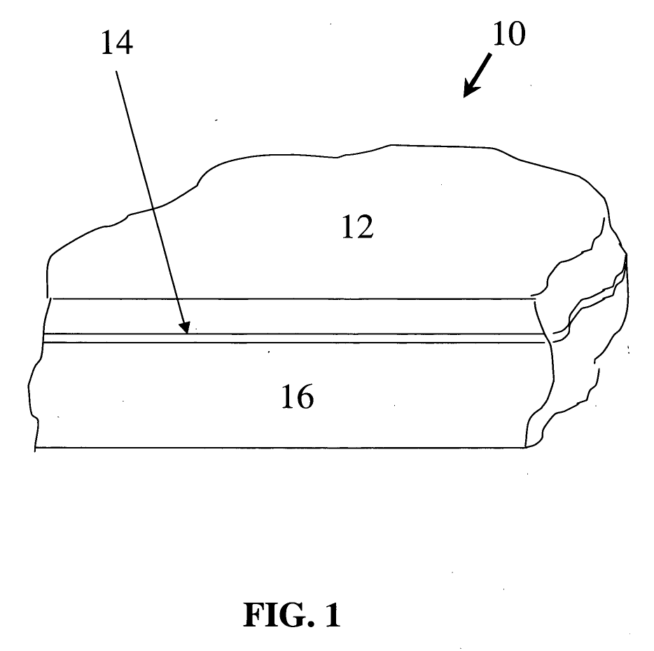

Referring to FIG. 1, a cross-section of a laminated panel 10 according to a first embodiment of the invention comprises a polymer-based material sheet 12 bonded to a major surface of a substrate 16 by an adhesive layer 14. The laminated panel 10 can be used for concrete forming purposes. The laminated panel 10 can be flat or shaped, as required.

The laminated panel 10 can be cut or sawed, nailed or screwed into, framed and clamped and otherwise used, handled and stored in the same manner as, and employing the same commercially available tools and equipment and standard industry practices currently employed with, non-metal concrete forming products employed in normal building and constructions applications and conditions.

According to a further embodiment, the polymer-based composite material sheet 12 comprises one or more polymeric materials, such as a thermoplastic material or a thermoset material, and one or more functional filler materials. Preferably, one or more thermoplastic materials, such as polyethylene, polypropylene, and/or PVC, is used in an amount of at least approximately 40% and up to approximately 95% by the weight of the total composition of the composition, and the functional fillers are used in the amount of the balance of the composition, either individually or in combination. Typically, the sheet 12 includes between 55% and 75% of the one or more thermoplastic materials by weight, and between 25% and 45% of the one or more functional filler materials by weight. Exemplary functional fillers include various types of metals, ceramics, carbon (both activated and not activated), flyash, glass, natural and synthetic fibers, aramids, natural and synthetic rubbers and related materials, hardwood sawdust, and combinations thereof. The amount, type (e.g., virgin or recycled), form (e.g., powder, beads, or fiber), grade/quality, and particle size and shape of the filler materials can be chosen to provide a desirable surface finish, a desirable surface hardness, and desirable release characteristics to the laminated panel 10.

The polymer-based composite material sheet 12 provides easy, quick, and clean release from the cured concrete without the use of a release agent, such as form oil or diesel oil or chemicals, of either a barrier or reactive type. Laminated panels 10 comprising the polymer-based composite material sheet can be used to construct reusable concrete pouring forms. For example, the laminated panels can be used for at least 30 pours without release agents. The quick, easy, and clean release properties of the polymer-based composite material sheet 12 are such that the surfaces of both the cured concrete and the polymer-based composite material sheet 12 are smooth and undamaged after the laminated panel 10 is removed from the cured concrete. The panels can be used to construct and disassemble concrete pouring forms using commercially available building and constructions industry tools, equipment, and standard practices.

While not wishing to be bound by theory, it is believed that the quick, easy, and clean release capability of the polymer-based composite material sheet without release agents of the present invention is provided at least in part by the low surface energy of the sheet. The low surface energy results from the combination of the types and amounts of polymers and functional fillers employed in the polymer-based composite material sheet 12 and the method by which the sheet 12 is manufactured. Surface energy may be determined, for example, by measuring the contact angle formed by a droplet of distilled water upon the sheet 12. The more that the water droplet “beads up”, the greater the contact angle is, and the lower the corresponding surface energy is. For example, one polymer-based composite material sheet 12 was measured to have a surface energy of approximately 24.5 dynes/cm. In a preferred embodiment of the present invention, a typical sheet 12 may have a surface energy that is less than or equal to approximately 30 dynes/cm.

It is also believed that a high surface hardness of the sheet 12 contributes to the ability of the sheet 12 to be removed from the cured concrete quickly, easily, and cleanly, thus enabling both the surface of the cured concrete and the surface of the sheet to be smooth and undamaged. Surface hardness is measured on the Rockwell (“R”) hardness scale, using, for example, the ASTM D785-98 test. In a preferred embodiment of the invention, the polymer-based composite material sheet 12 has a surface hardness of at least 30 on the Rockwell scale.

The polymer-based composite material sheet 12 also permits the removal of residual concrete mineral dust, if any, from, and general cleaning of, the surface of the sheet by simple hand-dusting with a cloth, or rinsing with water employing a cloth or brush (e.g., commercially available non-metal bristle brushes), as appropriate, after the form is removed from the cured concrete. The polymer-based composite material sheet 12 can incorporate functional or decorative surface textures, patterns, or designs, which surface treatments also do not require the use of release agents for quick, easy, and clean release or any change in the method of cleaning as set forth above. The polymer-based composite material sheet 12 preferably has a thickness of at least approximately eight one-thousandths of an inch (0.008″), which is the typical thickness of thin MDO overlay, without affecting the performance of the material as regards: 1) quick, easy and clean release of the form from cured concrete without release agents, and 2) durability of the material for commercial concrete pouring purposes for at least 30 pours.

The substrate 16 can be a plywood or other celluloid, metal, or composite material that complies with the structural, dimensional stability, and other performance specifications required by the building and construction industry for concrete forming products, for example, APA-rated plywood. The adhesive layer 14 can comprise one-part acrylics, two-part acrylics, epoxies, polyurethanes, phenolics, hot-melt adhesives, polyvinyl acetates, ethylene vinyl acetates, and/or pressure-sensitive adhesives, individually, in combination, and/or compounded together. The adhesive used should be unaffected by water, alkali, and petrochemicals. The adhesive additionally should be used in an amount sufficient to bond effectively to both the polymer-based composite material sheet 12 and to the various materials employed for the substrate as indicated above. According to a preferred embodiment, the bond will remain intact and effective for the useful commercial life of panel 10 (i.e., for at least 30 pours), including the removal of the laminated panel 10 from the cured concrete, and handling, cleaning, and storage of panel 10 employing standard industry tools, equipment, and practices for non-metal concrete forming products in normal commercial building and construction applications and conditions.

According to a preferred embodiment, the adhesive bond to the polymer-based composite material sheet 12 may be enhanced by surface treatment (e.g., corona discharge, flame treatment, and/or plasma treatment) of the face of the sheet being bonded. The polymer-based composite material sheet 12 also can be used independently as a facing or liner for metal substrates for concrete forming purposes. If a suitable adhesive is applied, polymer based sheet 12 can be applied in the field to existing, new, or used forms, both metallic and non-metallic.

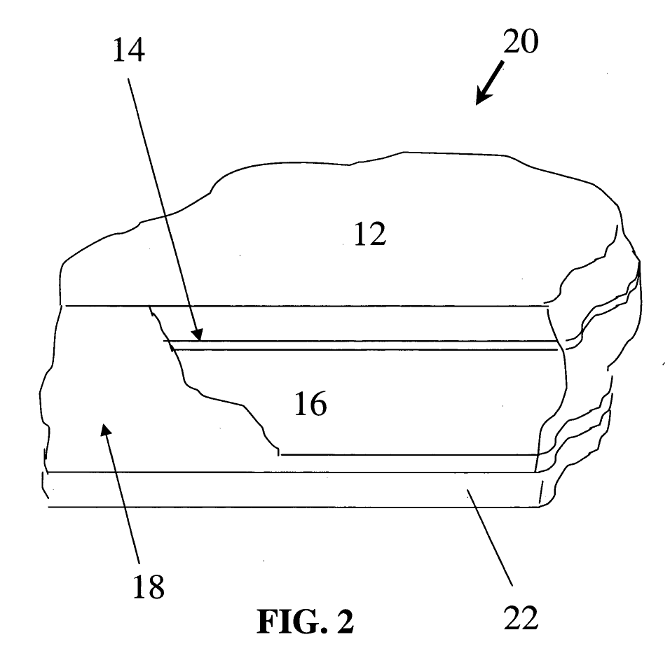

Referring to FIG. 2, a cross-section of laminated panel 10 according to a further embodiment of the invention comprises a coating 18 on the exposed surfaces of substrate 16. The coating is preferably waterproof, alkali and petrochemical resistant, and impact and abrasion resistant for the useful commercial life of the laminated panel (i.e., at least 30 pours). The coating 18 can be a paint formulation. The coating 18 may include a thermal insulating filler, for example, ceramic particles of one or more types and particle shapes and/or sizes, and/or a radiant heat reflecting filler comprising metallic particles of one or more types and shapes and/or sizes, and/or foils.

The coating 18 provides quick, easy, and clean release and removal, by hand in most cases, of any concrete that may be splashed or spilled on it during use of the laminated panel 10 without any functional damage to the coating 18. As desired for aesthetic purposes, any concrete mineral dust remaining on the coating 18 after removal of the splashed or spilled concrete can be cleaned further with water by employing a cloth or commercially available non-metal bristle brush, as appropriate. The coating 18 also can be provided in various colors for inventory management, security, and/or asset control purposes.

The laminated panel 10 can be attached and secured to a concrete forming frame or otherwise positioned and secured in the desired orientation or alignment in a free-standing configuration using, for example, nails, screws, or clamps. Holes in the substrate 16 and/or coating 18 remaining after the nails and screws are removed can be resealed with coating 18 in the field to restore the laminated panel 10 to its original condition.

According to an alternative embodiment, in lieu of applying coating 18 to the surface of the exposed face of substrate 16, a polymer-based composite material sheet 12 or an appropriate alternative polymer sheet can be bonded by an adhesive layer 14 to that surface, thus creating a dual-faced laminated panel 10 with a useful commercial life of at least 60 pours (i.e., at least 30 pours for each face of the dual-faced laminated panel 10) when the polymer-based composite material sheet 12 is applied to that surface.

According to a preferred embodiment, the exposed edges of the substrate 16 can be coated and sealed with coating 18 to prevent swelling of and physical damage to the substrate 16 due to exposure to water and handling in multiple uses. According to an alternative embodiment, an appropriate commercially available edge sealant can also be used.

Polymer-based composite material sheets having various formulations were produced in the laboratory. The sheets comprised a polymer and one or more functional fillers. The formulations used for the polymer-based composite material sheets included polypropylene, polyethylene, and PVC polymers in amounts by weight ranging from 40% to 75% of the total formulation. The functional fillers used were selected from the group consisting of various types (i.e. virgin or recycled), forms (e.g., powder, beads, or fiber), grades/quality, and particle sizes and shapes of metals, ceramics, carbon (both activated and not activated), flyash glass, aramids, natural and synthetic rubbers and related materials, hardwood sawdust, and combinations thereof. The functional fillers made up the balance of the composition by weight.

According to one embodiment, a polymer-based composition material sheet is provided which comprises 55% to 65% high density polyethylene, 28%-42% powdered alumina, and 3%-7% milled carbon fiber, by weight. The polymer-based composite material sheets preferably have a thickness of at least approximately eight one-thousandths of an inch (0.008″).

The polymer-based composite material sheets were bonded to a major surface of a celluloid substrate by an adhesive layer. The celluloid substrate was seven-ply plywood having a thickness of 0.75 inches. Preferred adhesives include one-part acrylics, two-part acrylics, epoxies, polyurethanes, phenolics, hot-melt adhesives, polyvinyl acetates, ethylene vinyl acetates, and/or pressure-sensitive adhesives, individually, in combination, and/or compounded together. The surface of the celluloid substrate to be bonded is preferably clean, dry, and free of dust, oils, and other foreign materials. The surface of the polymer-based composite material sheet to be bonded is also preferably clean, dry, and free of dust, oils, and other foreign materials. The surface of the polymer-based composite that is to be bonded to the substrate can also be roughened and/or flame treated to improve adhesion.

The exposed surfaces of the plywood substrate, including the face of the plywood opposite the face onto which the polymer-based composite material was bonded and the exposed edges of the plywood, were coated with a water-based, quick-drying paint composition. The preferred paint composition comprises 5%-20% by weight of a ceramic filler.

For some panels, commercially available edge sealant products were used to seal the edges. The coating was used to impart water and enhanced abrasion resistance to the exposed surfaces of the plywood and thereby extend the useful life of the panel at least to 30 pours. The ceramic filler was added to provide additional thermal insulation to the composite panel which may aid in curing the cementitious composition. Two or more coats of the paint composition can be applied. The coating can be applied using commercially available brushes, rollers, and spray equipment.

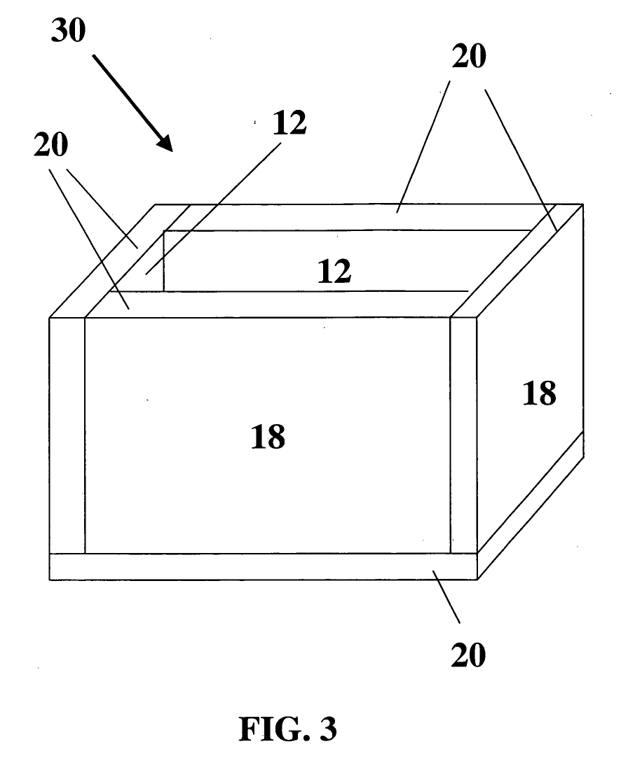

The resulting laminated panel was used to form the wall and based of an open-top container (i.e., a concrete pour form) having a rectangular cavity with internal dimensions of approximately 5″ width×10″ height×12″ length, with the polymer-based composite material sheet facing toward and forming the interior surfaces of the container. Referring to FIG. 3, a schematic of the concrete pour form 30 is illustrated. The concrete pour form 30 was filled With a concrete composition comprising a very high alkalinity cement mix with various aggregates of various sizes and shapes, including sand and gravel with sharp edges. No form oil or other oils or release agents were applied to the surfaces of the polymer-based composite material sheets prior to pouring the concrete composition into the form 30. The concrete in form 30 was vibrated and tamped to remove trapped air and condense the composition in accordance with standard building and construction industry practice. The concrete composition was then cured in place in the container.

When the concrete was cured, the container was then disassembled and the cured concrete block was removed. The polymer-based composite material sheets forming the interior faces of the walls and base of the container released easily from the cured concrete block when the laminated panel samples were disassembled and removed from the cured concrete block. The surfaces of the polymer-based composite material sheets were smooth, and no damage to any of the surfaces of the polymer-based composite material sheets was observed. Further, any residual concrete mineral dust remaining on the surface of the polymer-based composite material sheets washed off easily with water, and the concrete composition that was splashed or spilled on the coating applied on the exposed surfaces of the substrates also was removed easily by hand without any damage to the coating.

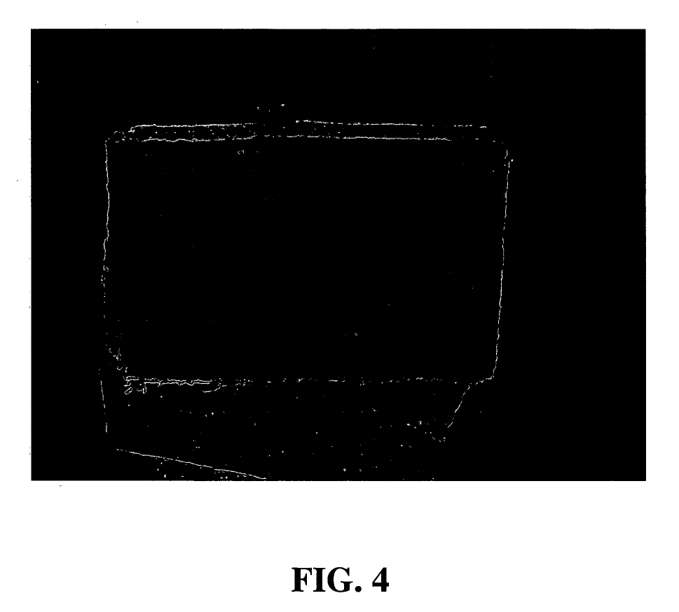

Referring to FIG. 4, a concrete block made using the concrete pour form 30 is shown. As can be seen from FIG. 4, the concrete block does not exhibit imperfections and has a relatively smooth surface texture.

The container 30 was reassembled and used to make additional concrete blocks. Nearly 50 such additional concrete blocks were produced while employing the same form in the manner described above. In each case: 1) the polymer-based composite material sheets forming the interior faces of the walls and base of the concrete pour form released quickly, easily, and cleanly from the cured concrete block when the sample laminated panels were removed; 2) no damage to the surface of the polymer-based composite material sheets was observed; 3) residual concrete mineral dust, if any, remaining on the surface of the polymer-based composite material sheets washed off easily with water; 4) any concrete composition that was splashed or spilled on the coating applied on the exposed surfaces of the substrates also was removed easily and quickly by hand without any damage to the coating, and any residue was washed off easily with water; and 5) these additional concrete blocks also did not exhibit imperfections and had a relatively smooth surface texture. Accordingly, the laminated panels can be used repeatedly for concrete pouring applications without release agents of any kind.

Larger, commercial size samples of laminated panels 10 of a seven-ply plywood substrate 16 having dimensions of 0.75″ thickness×4′ width×8′ length, for which exposed surfaces of the substrates were coated with the coating 18, also were produced employing a manufacturing process similar to that which will be employed to make commercial laminated panels. Laboratory and field tests of these larger samples provided the same results, indicated above, as were obtained from the laboratory tests employing the concrete pour form 30, thus confirming that the larger laminated panels also can be used repeatedly for concrete pouring applications without release agents of any kind.

Referring to Table 1 below, several composite materials that may be used for concrete pouring applications according to the present invention have been tested. In each instance, the thermoplastic material used is high density polyethylene, and the filler materials include either alumina, carbon fiber, or both alumina and carbon fiber. Each composite material was provided with a sample label and tested for surface energy, using the contact angle test, and for surface hardness, using the Rockwell R Hardness ASTM D785-98 test. The results are shown in Table 1.

TABLE 1

| | | | | Rockwell | Avg. |
|---|---|---|---|---|---|
| | | | | R | Surface |
| Composite | Weight % | | | Hardness | Energy |
| Sample | High Density | Alumina | Carbon | ASTM | (n = 3) |
| Label | Polyethlylene | (Al2O3) | Fiber | D785-98 | (dyne/cm) |
| 114-A | 60 | 35 | 5 | 51 | 21 |
| 114-B | 100 | 0 | 0 | 48 | 24 |
| 114-C | 60 | 30 | 10 | 68 | 22 |
| 114-D | 55 | 35 | 10 | 63 | 32 |
| 114-E | 60 | 25 | 15 | 41 | 25 |
| 114-F | 50 | 35 | 15 | 41 | 25 |
| 114-G | 60 | 40 | 0 | 55 | 21 |
| 114-H | 65 | 35 | 0 | 55 | 19 |
| 114-I | 70 | 30 | 0 | 35 | 10 |
| 114-J | 55 | 40 | 5 | 56 | 20 |
| 114-K | 55 | 45 | 0 | 63 | 18 |
| 114-L | 70 | 25 | 5 | 19 | 21 |
| 114-M | 95 | 0 | 5 | 38 | 10 |
| 114-N | 90 | 0 | 10 | 19 | 17 |
| 114-O | 85 | 0 | 15 | 22 | 18 |
| HDO | | | | 30 | 22 |
| Forming | | | | | |
| Plywood | | | | | |

In alternative embodiments of the present invention, the composite material may include other types of polymer materials and other types of filler materials. Polymer materials that may be used to produce the composite material for the sheet 12 include thermoplastics, thermosets, elastomers, PET, HDPE, LDPE, LLDPE, PVC, PP, PS, polyamides, polyesters, polycarbonates, recycled polymers, PBT, polyketones, phenolics, ABS, and SAN. Filler materials that may be used to produce the composite material for the sheet 12 include minerals, talc, mica, silicones, fluorinated polymers, aramids, natural fibers, glass fibers, carbon fibers, ceramics, carbides, oxides of silicon, titanium, zirconium and magnesium, clays, and nitrides.

While the present invention has been described with respect to what is presently considered to be the preferred embodiment, it is to be understood that the invention is not limited to the disclosed embodiments. To the contrary, the invention is intended to cover various modifications and equivalent arrangements included within the spirit and scope of the appended claims. The scope of the following claims is to be accorded the broadest interpretation so as to encompass all such modifications and equivalent structures and functions.

What is claimed is:

1. A composite material for use in a concrete pouring form, the composite material comprising at least one thermoplastic material and at least one filler material, the thermoplastic material being selected from the group consisting of polyethylene, polypropylene, and PVC,
wherein at least one surface of the composite material is configured for contact with at least one surface of cured concrete, and
wherein the composite material can be separated from cured concrete without using a release agent, leaving the at least one surface of the composite material and the at least one surface of cured concrete smooth and undamaged.

2. The composite material of claim 1, wherein the at least one filler material is selected from the group consisting of a metal, a ceramic, activated carbon, non-activated carbon, flyash, glass, a natural fiber, a synthetic fiber, an aramid, a natural rubber, a synthetic rubber, sawdust, and combinations thereof.

3. The composite material of claim 1, wherein respective amounts by weight of the thermoplastic material and the filler material are provided such that the composite material has a surface energy of less than or approximately equal to 30 dynes/cm.

4. The composite material of claim 1, wherein respective amounts by weight of the thermoplastic material and the filler material are provided such that the composite material has a surface hardness of greater than or approximately equal to 30 on the Rockwell scale.

5. The composite material of claim 1, wherein respective amounts by weight of the thermoplastic material and the filler material are provided such that the composite material has both a surface energy of less than or approximately equal to 30 dynes/cm and a surface hardness of greater than or approximately equal to 30 on the Rockwell scale.

6. The composite material of claim 3, 4, or 5, wherein the amount by weight of the thermoplastic material constitutes at least 40% and at most 95% of the weight of the composite material, and the amount by weight of the filler material constitutes at least 5% and at most 60% of the weight of the composite material.

7. The composite material of claim 3, 4, or 5, wherein the amount by weight of the thermoplastic material constitutes at least 55% and at most 75% of the weight of the composite material, and the amount by weight of the filler material constitutes at least 25% and at most 45% of the weight of the composite material.

8. The composite material of claim 1, wherein the composite material exhibits desired release characteristics for at least 30 concrete pours without using a release agent.

9. The composite material of claim 1, which is formed into a sheet and bonded to at least one face of a substrate by using an adhesive to form a laminated panel, the substrate being selected from the group consisting of plywood, a celluloid, a metal, and a second composite material.

10. The composite material of claim 9, wherein the adhesive is selected from the group consisting of one-part acrylics, two-part acrylics, epoxies, polyurethanes, phenolics, hot-melt adhesives, polyvinyl acetates, ethylene vinyl acetates, and pressure-sensitive adhesives, individually, in combination, and/or compounded together.

11. The composite material of claim 9, wherein the sheet has a thickness of at least approximately eight one-thousandths of an inch.

12. The composite material of claim 9, in which exposed surfaces of the substrate are coated, the coating allowing the removal of excess concrete with which the substrate might come into contact during a concrete pour.

13. The composite material of claim 12, wherein the coating comprises ceramic particles.

14. The composite material of claim 12, wherein the coating comprises metallic particles.

15. The composite material of claim 9, in which a second sheet of composite material is bonded to an opposite face of the substrate using an adhesive to form a dual-faced laminated panel, and wherein each face of the dual-faced laminated panel withstands at least 30 concrete pours without using a release agent.

16. The composite material of claim 1, which has undergone a surface treatment to improve adhesion to a substrate.

17. The composite material of claim 16, wherein the surface treatment is selected from the group consisting of a corona discharge, a flame treatment, a plasma treatment, and combinations thereof.

18. The composite material of claim 1, at least one surface of which includes an adhesive selected from the group consisting of one-part acrylics, two-part acrylics, epoxies, polyurethanes, phenolics, hot-melt adhesives, polyvinyl acetates, ethylene vinyl acetates, and/or pressure-sensitive adhesives, individually, in combination, and/or compounded together.

19. The composite material of claim 18, further comprising a removable protective layer positioned over at least a portion of the adhesive.

20. A method of making a laminated panel useful in concrete pouring applications, comprising the steps of:
providing a composite material, the composite material including at least one thermoplastic material and at least one filler material;
forming the composite material into a sheet having a substantially uniform thickness; and
bonding the sheet to the substrate to provide a laminated panel that can be released from cured concrete without using a release agent such that at least one surface of the laminated panel and at least one surface of the cured concrete are left smooth and undamaged.

21. The method of claim 20 in which the sheet is bonded to the substrate using an adhesive.

22. The method of claim 20, further comprising contacting a face of the laminated panel, which comprises the composite material, with poured concrete.

23. The method of claim 20, wherein the at least one thermoplastic material is selected from the group consisting of polyethylene, polypropylene, and PVC.

24. The method of claim 20, wherein the at least one filler material is selected from the group consisting of a metal, a ceramic, activated carbon, non-activated carbon, flyash, glass, a natural fiber, a synthetic fiber, an aramid, a natural rubber, a synthetic rubber, sawdust, and combinations thereof.

25. The method of claim 21, wherein the adhesive is selected from the group consisting of one-part acrylics, two-part acrylics, epoxies, polyurethanes, phenolics, hot-melt adhesives, polyvinyl acetates, ethylene vinyl acetates, and/or pressure-sensitive adhesives, individually, in combination, and/or compounded together.

26. The method of claim 20, wherein respective amounts by weight of the at least one thermoplastic material and at least one the filler material are provided such that the composite material has a surface energy of less than or approximately equal to 30 dynes/cm.

27. The method of claim 20, wherein respective amounts by weight of the at least one thermoplastic material and the at least one filler material are provided such that the composite material has a surface hardness of greater than or approximately equal to 30 on the Rockwell scale.

28. The method of claim 20, wherein respective amounts by weight of the at least one thermoplastic material and the at least one filler material are provided such that the composite material has both a surface energy of less than or approximately equal to 30 dynes/cm and a surface hardness of greater than or approximately equal to 30 on the Rockwell scale.

29. The method of claim 26, 27, or 28, wherein the amount by weight of the at least one thermoplastic material constitutes at least 40% and at most 95% of the weight of the composite material, and the amount by weight of the at least one filler material constitutes at least 5% and at most 60% of the weight of the composite material.

30. The method of claim 26, 27, or 28, wherein the amount by weight of the at least one thermoplastic material constitutes at least 55% and at most 75% of the weight of the composite material, and the amount by weight of the at least one filler material constitutes at least 25% and at most 45% of the weight of the composite material.

31. The method of claim 20, wherein the substrate is selected from the group consisting of plywood, a celluloid, a metal, and a second composite material.

32. The method of claim 20, wherein the sheet has a thickness of at least approximately eight one-thousandths of an inch.

33. The method of claim 22, further comprising coating exposed surfaces of the substrate, the coating allowing the removal of excess concrete with which the substrate might come into contact during a concrete pour.

34. The method of claim 33, wherein the coating comprises ceramic particles.

35. The method of claim 33, wherein the coating comprises metallic particles.

36. The method of claim 20, in which the composite material has undergone a surface treatment to improve adhesion to the substrate.

37. The method of claim 36, wherein the surface treatment is selected from the group consisting of a corona discharge, a flame treatment, a plasma treatment, and combinations thereof.

38. A method of making a dual-faced laminated panel useful in concrete pouring applications, comprising the steps of:
providing a composite material, the composite material including at least one thermoplastic material and at least one filler material;
forming the composite material into a first sheet and a second sheet, each sheet having a substantially uniform thickness; and
bonding the first and second sheets to opposite faces of the substrate to provide a dual-faced laminated panel that can be released from cured concrete without using a release agent such that at least one surface of the dual-faced laminated panel and at least one surface of the cured concrete are left smooth and undamaged.

39. A composite material for use in a concrete pouring form, the composite material comprising at least one thermoplastic material and at least one filler material, the composite material being capable of being released from cured concrete without using a release agent, leaving faces of the composite material and the cured concrete previously in contact with each other smooth and undamaged.

40. A method of making a composite material for use in concrete pouring applications, the method comprising the steps of:
selecting at least one thermoplastic material and at least one filler material; and
combining the at least one thermoplastic material with the at least one filler material to provide a composite material that is capable of being released from cured concrete without using a release agent, leaving faces of the composite material and the cured concrete previously in contact with each other smooth and undamaged.

41. A method of pouring concrete to be cured, comprising the steps of:
lining a form into which concrete is to be poured with a composite material, the composite material including at least one thermoplastic material and at least one filler material, and
pouring concrete into the lined form,
wherein the composite material can be separated from the cured concrete without using a release agent, leaving faces of the composite material and the cured concrete previously in contact with each other smooth and undamaged.

42. A method of making a form useful in concrete pouring applications, the method comprising the steps of:
configuring a laminated panel into a form into which concrete can be poured, the laminated panel comprising a composite material bonded to a substrate, the composite material being capable of being released from cured concrete without using a release agent, leaving faces of the composite material and the cured concrete previously in contact with each other smooth and undamaged.

43. A composite material for use in a concrete pouring form, the composite material comprising at least one polymeric material and at least one filler material, the at least one polymeric material being selected from the group consisting of a thermoplastic material and a thermoset material,
wherein at least one surface of the composite material is configured for contact with at least one surface of cured concrete, and
wherein the composite material can be separated from cured concrete without using a release agent, leaving the at least one surface of the composite material and the at least one surface of cured concrete smooth and undamaged.

44. A method of making a laminated panel useful in concrete pouring applications, comprising the steps of:
providing a composite material, the composite material including at least one polymeric material and at least one filler material, and the at least one polymeric material including at least one of the group consisting of a thermoplastic material and a thermoset material;
forming the composite material into a sheet having a substantially uniform thickness; and
bonding the sheet to the substrate to provide a laminated panel that can be released from cured concrete without using a release agent such that at least one surface of the laminated panel and at least one surface of the cured concrete are left smooth and undamaged.
